(19) United States
(12) Patent Application Publication
(10) Pub. No.: US 2010/0090036 A1
(43) Pub. Date: Apr. 15, 2010

(54) Fluidic circuit with bump features for improving uniform distribution of fluidic sprays

(76) Inventors: Kerrie Allen, Laurel, MD (US); Gregory Russell, Catonsville, MD (US); Shridhar Gopalan, Westminster, MD (US)

Correspondence Address: J. ANDREW MCKINNEY & ASSOC., LLC, PO Box 1290, Millersville, MD, 21108, US

(21) Appl. No.: 12/564,232

(22) Filed: Sep. 22, 2009

Related U.S. Application Data
(60) Provisional application No. 61/136,745, filed on Sep. 30, 2008.
(60) Provisional application No. 61/136,744, filed on Sep. 30, 2008.

(51) Int. Cl. B05B 1/08; B23P 17/00

(52) U.S. Cl. 239/589.1; 239/600; 29/890.1

(57) ABSTRACT

A fluidic circuit or oscillator is provided with one or more small raised bumps or protrusions near the outlet or exhaust of a fluidic circuit to alter the spray pattern by re-distributing heavy areas of flow, resulting in a more uniform spray. The fluidic oscillator enclosure operates on a pressurized liquid flowing through the oscillator to generate a liquid jet that flows from said oscillator and into a surrounding environment to form an oscillating spray of liquid droplets, where the oscillator generates a stream of liquid droplets. The outlet or throat structure includes at least one bump or protuberance configured to project into the oscillating spray.

### PRIORITY CLAIMS AND REFERENCE TO RELATED APPLICATIONS

This application claims priority to related and commonly owned U.S. provisional patent application No. 61/136,745, filed Sep. 30, 2009, the entire disclosure of which is incorporated herein by reference. This application is commonly owned with related U.S. patent application Nos. 61/012,200, 61/136,744 and 12/314,242 the entire disclosures of which are also incorporated herein by reference.

### BACKGROUND OF THE INVENTION

1. Field of the Invention

The present invention relates to fluidic circuits and nozzle assemblies configured with fluidic oscillators and other fluidic circuits.

2. Discussion of the Prior Art

A fluidic nozzle creates a stream of fluid that oscillates within an included angle, known as the fan angle. The distribution of the fluid within this fan will vary depending on the type of fluidic circuit used. For example, in a mushroom circuit, the oscillating stream will tend to dwell briefly at the extremes of its travel, creating a fluid distribution or spray pattern that is called a heavy-ended fan. Some circuits may include a splitter, which can increase the maximum fan angle and spray velocity. In this case, the oscillating stream will tend to dwell on the splitter, causing a fluid distribution or spray pattern that is called a center-heavy fan.

The fluid distribution can be important in several applications for fluidic nozzles. In an irrigation nozzle, for example, it is desirable to distribute water evenly over a given area or shape (for example, a quarter circle.) If a heavy-ended fluidic were to be used in such a case, more fluid would be deposited on the edges of the spray, and less in the center. Furthermore, since the trajectory of the droplets is related to droplet size and velocity, the irrigation nozzle will tend to throw water further on the ends than in the middle. Many irrigation nozzle assemblies have spray patterns with several heavy bands.

Another common application for fluidic nozzles is to distribute windshield wiper fluid across a windshield, for cleaning. In this case, parts of the windshield may be covered with large amounts of wiper fluid, while other parts get only a light coating. In many cleaning applications, it is desirable to distribute fluid as evenly as possible over specific areas.

There is a need, therefore, for a convenient, flexible, inexpensive and unobtrusive fluidic structure and fluid distribution or spray method to distribute fluid in a more uniform pattern, or to broaden the performance envelope of a given set of fluidic circuits.

### OBJECTS AND SUMMARY OF THE INVENTION

Accordingly, it is an object of the present invention to overcome the above mentioned difficulties by providing a convenient, flexible, inexpensive and unobtrusive fluidic structure and fluid distribution or spray method to distribute fluid in a more uniform pattern, or to broaden the performance envelope of a given set of fluidic circuits.

In accordance with the present invention, a fluidic circuit and method can redistribute the bands of heavy flow, resulting in a more uniform flow distribution. Rather than introducing a new fluidic circuit which might carry its own advantages and disadvantages, this invention adds a feature that can be added to many fluidic circuit designs. The present invention is a passive solution, using no power or moving parts.

A bump or upwardly projecting protrusion or protuberance is added to the floor of the circuit downstream of the outlet's throat(s), near the heavy portion of the fan pattern or spray pattern defined by the oscillating stream of droplets. The protrusion projects “upwardly” in an arbitrary illustrative frame of reference and “upward” is a direction which is transverse to the direction of fluid flow, so that the protrusion projects into the passing flow of fluid (or “inwardly”).

In the exemplary embodiment, the protrusion is cylindrical in shape, but other shapes may be used. The protrusion does not take up the entire the height of the circuit. The fluidic circuit sweeps a stream of fluid back and forth across the opening. As the heavy stream passes over the protrusion, the flow is diverted over and around the protrusion, and broken into smaller drops. When the oscillating stream continues on to the end or extreme of its travel (at the edge of the fan pattern), the stream bypasses and is not affected by the protrusion. In a case where it is desirable to smooth the heavy center of a fluidic's spray without affecting the crisp edges of the spray, the protrusions are located closer to the splitter than to the outer edge of the spray. There are options for breaking up the heavy ends of a fluidic's spray. One large bump or protrusion can be used, centered within the sweep of the oscillating stream, or two substantially symmetrically arrayed equal-size protrusions may be used, closer to the edges of the spray. For a wider fan, using two protrusions will be more effective in redistributing the heavy ends. However, two separate bumps may not fit under a narrower fan, in which case, a single protrusion may be used. As noted before, the bumps or protrusions need not be circular in cross-section; an oval or racetrack-shaped protrusion is another option.

The effect of these protrusions makes the spray from a circuit more uniform, because heavy spikes in the spray pattern are suppressed and the spray's uniformity over a fan pattern defining a selected azimuth (or angular spray region) is improved.

Larger protrusions will have more of an effect on the spray. Applicants have been successful with protrusions 5-50% the height of the circuit. The diameter of the protrusions can vary from a fraction of the throat width to the same order of magnitude as the throat width.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1A is a perspective view of a fluidic pop-up irrigation nozzle or sprinkler head illustrating the placement of the fluidic nozzle spraying inserts, in accordance with the present invention.

FIG. 1B is an exploded perspective view of the fluidic pop-up irrigation nozzle of FIG. 1A, illustrating the placement of ports or slots configured to receive the fluidic nozzle spraying inserts, in accordance with the present invention.

FIG. 2 illustrates, in perspective, fluidic circuit A, with a top oscillator on one side of the fluidic chip or insert (see FIG. 3) and a bottom oscillator on the opposing side of the fluidic chip (as best seen in FIG. 4).

FIG. 3 illustrates a top view schematic diagram of fluidic circuit A showing the top split mushroom oscillator of FIG. 2, and the fan angles for the light center and heavy ended bands of spray are shown as part of the overall fan angle of spray.

FIG. 4 illustrates a bottom view schematic diagram of fluidic circuit A showing the bottom mushroom oscillator of FIG. 2, and the fan angles for the light center and heavy ended bands of spray are shown as part of the overall fan angle of spray.

FIG. 5 illustrates, in cross section, a nozzle assembly including fluidic circuit A (of FIGS. 2-5), and illustrates the aim angles and spray trajectories for the top and bottom sprays emitted from the top split mushroom oscillator and the bottom mushroom oscillator, respectively.

FIG. 6 is a schematic diagram showing a perspective view of a split fluidic circuit having first and second upwardly (or inwardly) projecting protrusions or “bump” features at the outlet, to increase the uniformity of the spray emitted from the fluidic circuit, in accordance with the present invention.

FIG. 7 is a contour plot illustrating measured uniformity of the spray emitted from the fluidic circuit providing “heavy bands” in their spray pattern, in accordance with the applicants' work in present invention.

FIG. 8 is a top view of the split fluidic circuit of FIG. 6, illustrating the diameters and lateral placement for the first and second upwardly projecting protrusions or “bump” features at the outlet, to increase the uniformity of the spray emitted from the fluidic circuit, in accordance with the present invention.

FIG. 9 is a top view of another fluidic circuit, illustrating diameter and lateral placement of a single upwardly projecting protrusion or “bump” feature at the outlet, to increase the uniformity of the spray emitted from the fluidic circuit, in accordance with the present invention.

FIG. 10 is a top view of yet another fluidic circuit, illustrating diameter and lateral placement of a first and second upwardly projecting protrusions or “bump” features at the outlet, to increase the uniformity of the spray emitted from the fluidic circuit, in accordance with the present invention.

FIG. 11 is a contour plot illustrating measured improved uniformity of the spray emitted from the same fluidic circuit for which performance was depicted in FIG. 7, showing the substantial elimination of “heavy bands” in the spray pattern, in accordance with the present invention.

FIG. 12 illustrates, in perspective, a yawed mushroom oscillator adapted for use in the nozzle assembly of the present invention.

FIG. 13 illustrates a top view schematic diagram of the yawed mushroom oscillator of FIG. 12, and the yaw angle and fan pattern for the oscillator's band of spray, in accordance with the present invention.

### DESCRIPTION OF THE PREFERRED EMBODIMENT

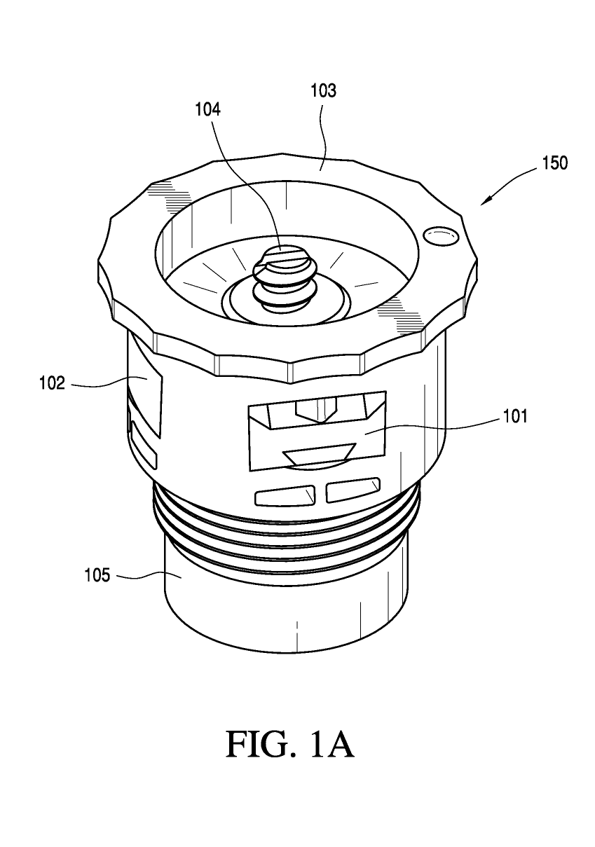

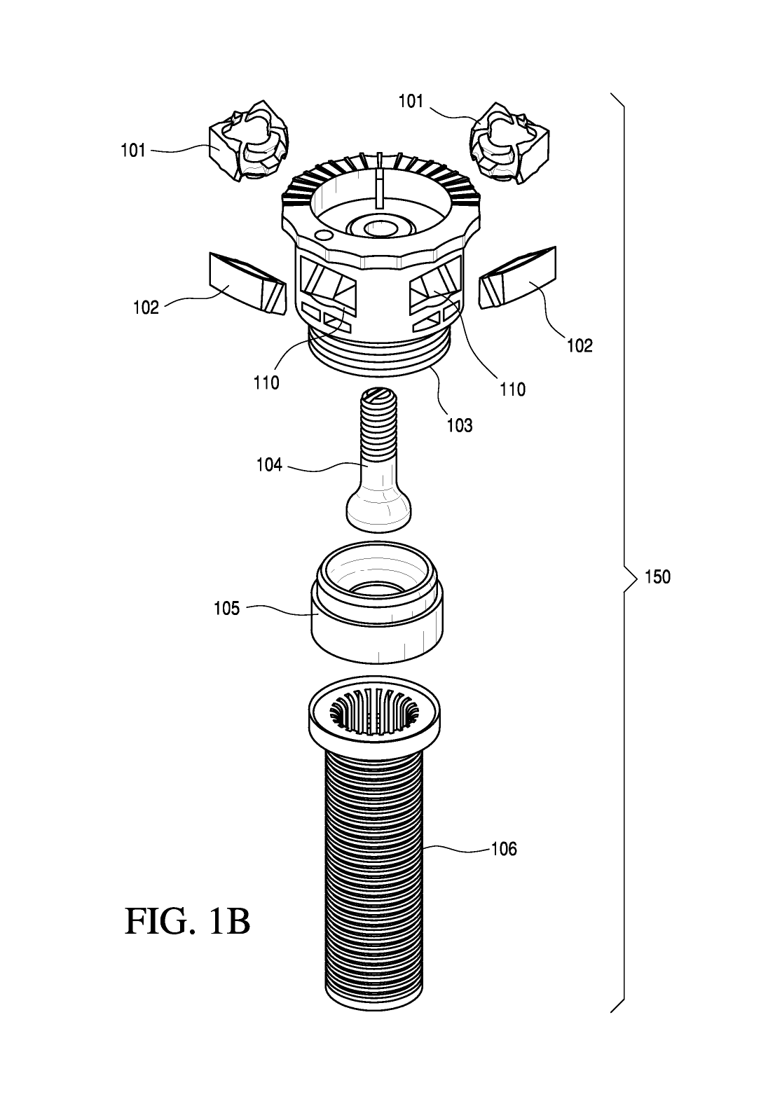

Referring now to FIGS. 1A-13, fluidic circuits are often configured for use in housings which define a channel, port or slot that receives and provides boundaries for the fluid paths defined in the fluidic circuit. For an illustrative example of how a fluidic oscillator or fluidic circuit might be employed, as shown in FIGS. 1A-5, a sprinkler or nozzle assembly 150 is configured with a substantially cylindrical housing 103 with a hollow interior. Housing 103 defines a substantially tubular fluid-impermeable structure and the housing sidewall includes an array of four upwardly angled ports or slots 110, each defining a substantially rectangular passage or aperture with smooth interior slot wall surfaces. The interior sidewall surfaces are preferably dimensioned for cost effective fabrication using molding methods and preferably include sidewall grooves positioned and dimensioned to form a “snap fit” with ridges or tabs in mating fluidic circuit inserts (e.g., 101) or blanks (e.g. 102).

Nozzle assembly 150 can be configured to include one, two, three or four fluidic circuit inserts or chips 101 which are dimensioned to be tightly received in and held by the radially arrayed slots 110 defined within the sidewall of housing 103. The ports or slots 110 provide a channel for fluid communication between the housing's interior lumen and the exterior of the housing. Housing 103 has a distal or top closed end with an axially aligned, threaded bore that threadably receives an axially aligned flow adjustment screw 104 which defines a flow-restricting valve plug end.

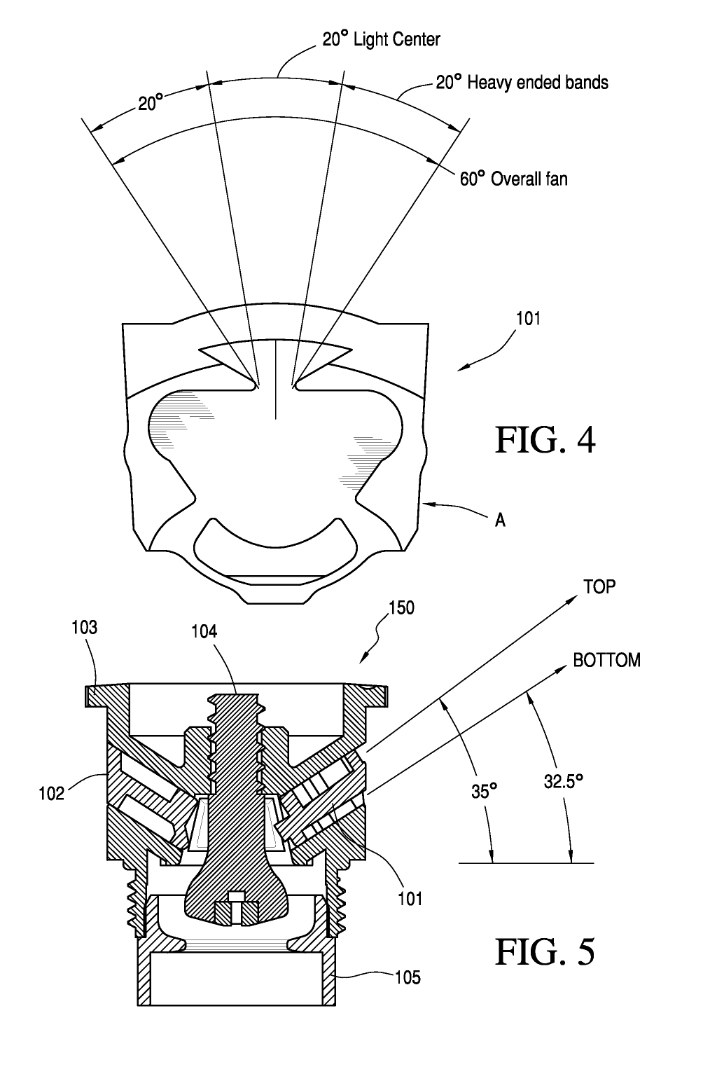

The cross sectional view of FIG. 5, illustrates the fluidic irrigation nozzle assembly housing 103 slots 110 in cross section, when spray generating fluidic inserts 101 have been inserted. In the elementary form, a selected fluidic insert (such as a Three Jet Island or a Mushroom (e,g., as shown in FIG. 4)) is used to produce an oscillating 90 degree wide fan-shaped pattern of spray. This could be a single spray or a double spray (e.g., as shown in FIG. 5), where the fluidic insert has a fluidic geometry on both sides (top and bottom) of the insert.

The internal structures of the fluidic oscillators are further described in this applicant's other patents and pending applications. For example, the “Mushroom” oscillator as shown in FIG. 4 includes an oscillation inducing chamber described in U.S. Pat. No. 6,253,782 (and an improved mushroom is described in U.S. Pat. No. 7,267,290); the “Double Spray” configuration is described in U.S. Pat. No. 7,014,131; the “Three Jet” island oscillator has power nozzles feeding an interaction region and is described in U.S. Patent Application Publication 2005/0087633; and the “Split Throat” oscillator includes internal nozzles feeding an interaction chamber and is described in U.S. Patent Application Publication 2007/0295840. The entire disclosure of each the foregoing patents and published applications (describing fluidic oscillators and inserts which could be altered by the addition of the bump features of the present invention) are incorporated herein by reference.

In more general terms, housing 103 provides an enclosure for a fluidic oscillator or circuit (e.g., 101) that operates on a pressurized fluid or liquid flowing through the oscillator to generate a liquid jet that flows from the oscillator and into a surrounding environment to form an oscillating spray of liquid droplets, where the oscillator has a boundary surface fabricated therein defining a channel (bounded by port 110) to provide a fluidic circuit whose geometry is configured to aid in establishing the oscillating nature of the spray of liquid droplets. Enclosure 103 includes or defines a body having an interior and an exterior surface; where a first portion of the interior surface is configured to attach to the oscillator boundary surface and form with the channel 110 an enclosed pathway through which the liquid flows. For the embodiments shown in FIGS. 3, 6 and 8 a second portion of the interior surface is configured to provide a one or more throats through which the pressurized liquid exhausts as the oscillating spray.

In accordance with the present invention, at least one throat in the second portion includes at least one bump, protrusion or protuberance (e.g., 600 or 604) configured to project upward or transversely into the outward flow of the pressurized liquid. A bump or upwardly projecting protrusion is added to the floor of the circuit downstream of the throat, near the heavy portion of the spray. The protrusion projects “upwardly” in an illustrative frame of reference wherein “upward” is a direction which is transverse to the direction of exhausting or spraying fluid flow, so that the protrusion projects into the passing flow of fluid (or “inwardly”) as that fluid passes through the outlet of the fluidic circuit or oscillator.

The enclosure can have a body configured as housing 103, with the exterior surface including a front (or exterior) face and a rear (or interior) face and an intermediate boundary surface that connects the faces, and the interior surface includes a passage (e.g., port 110) that extends between the faces, with the passage having a front and a rear section, the passage rear section forming a cavity having an opening in the body rear face (or interior) where the cavity is configured to allow for the insertion of a fluidic oscillator (e.g., 101 or 601) into the cavity, and where the passage front section is configured to include or define the throats (or outlet, where the fluid is exhausted). At least one throat in the front (or exterior) section includes at least one spray altering bump, protrusion or protuberance (e.g., 600) which is configured to project upwardly or transversely and into the flow of the exhausting pressurized liquid to alter the pattern or bands of liquid flow and to render a substantially uniform pattern from the jet's oscillating spray.

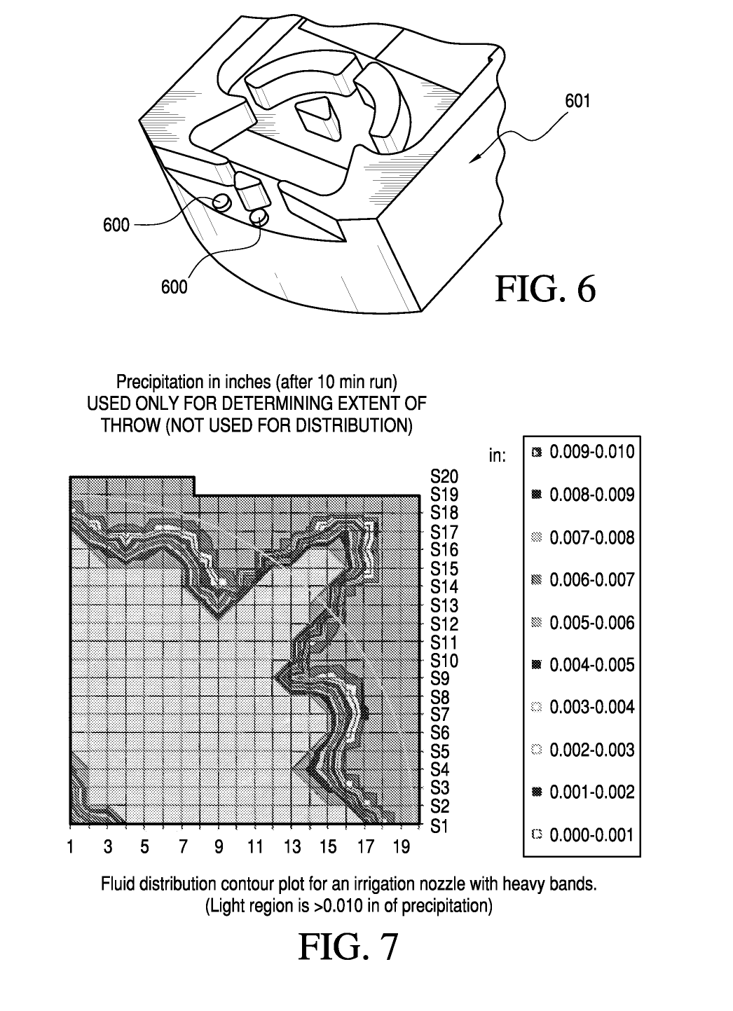

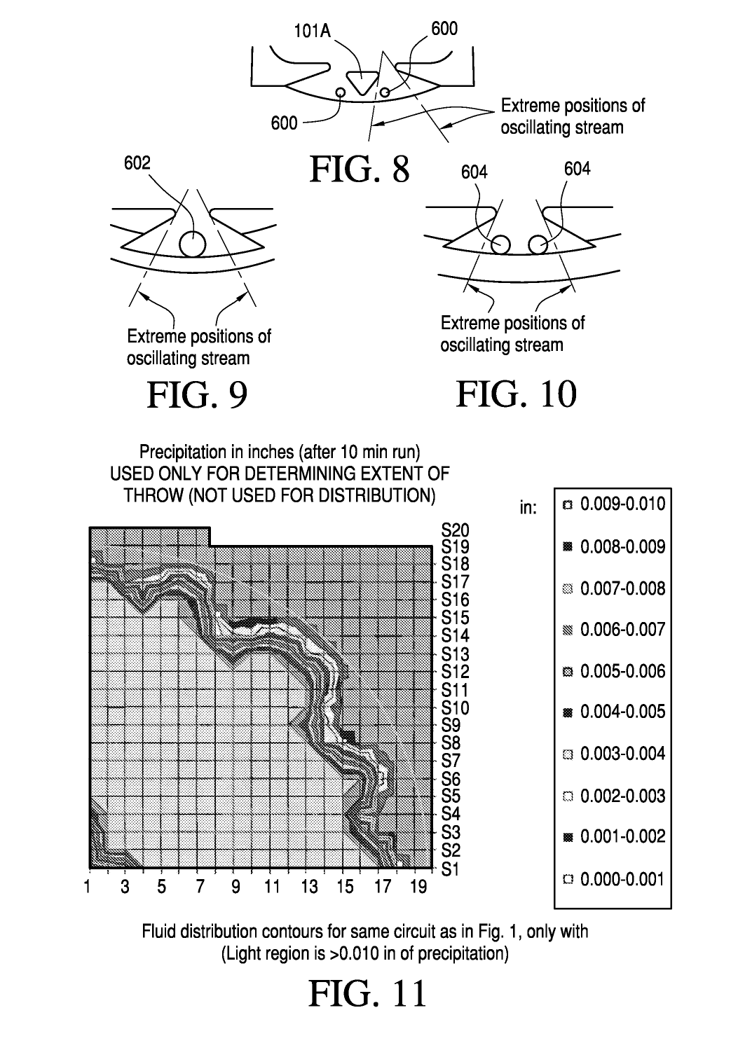

FIGS. 6-13 illustrate an illustrative embodiment for the fluidic circuit structure and spray distribution uniformity control method of the present invention. Referring to FIGS. 6 and 8, a pair of upwardly projecting cylindrical-section bumps or protrusions 600 are added to the floor of the circuit proximate the outlet and downstream of the throats, and are positioned at the outlet near the paths for the heavy portions of the spray. In the illustrated embodiments of FIGS. 8-10, 12 and 13, each bump or protrusion is substantially cylindrical in shape, but other shapes may be used. The protrusion does not take up the entire the height of the circuit, and so fluid or liquid passing past and over the top or distal end of the bump is deflected or re-directed.

### Special Considerations for Spray Pattern Uniformity

As noted above, a fluidic nozzle creates a stream of fluid that oscillates within an included angle, known as the fan angle (e.g., 60 degrees for fluidic 101 of FIG. 4). The distribution of the fluid within this fan will vary depending on the type of fluidic circuit used. For example, in a mushroom circuit (e.g., as shown in FIG. 4), the oscillating stream will tend to dwell briefly at the extremes of its travel (i.e., the left end and the opposing right end of the fan pattern), creating a fluid distribution or spray pattern that is called a heavy-ended fan. Some circuits may include a splitter (e.g., 101A as shown in FIG. 3), which can increase the maximum fan angle and spray velocity. In this case, the oscillating stream will tend to dwell on the splitter 101A, causing a fluid distribution or spray pattern that is called a center-heavy fan.

The fluid distribution can be important in several applications for fluidic nozzles. In an irrigation nozzle, for example, it is desirable to distribute water evenly over a given area or shape (for example, a quarter circle.) If a heavy-ended fluidic were to be used in such a case, more fluid would be deposited on the edges of the spray, and less in the center. Furthermore, since the trajectory of the droplets is related to droplet size and velocity, the irrigation nozzle will tend to throw water further on the ends than in the middle. FIG. 7 shows an example irrigation spray that has several heavy bands.

FIGS. 6-13 illustrate embodiments for a fluidic circuit structure and method of the present invention. Referring to FIGS. 6 and 8, a pair of upwardly projecting cylindrical-section bumps or protrusions 600 are added to the floor of the circuit 601 downstream of the throat, near the heavy portion of the spray (see FIG. 8). In the illustrated embodiments, each bump or protrusion 600 is substantially cylindrical in shape, but other shapes may be used. The protrusion does not take up the entire the height of the fluid conduit defined within circuit 601.

In use, fluidic circuit 601 sweeps a stream of fluid back and forth across the outlet's opening. As the heavy stream passes over transversely projecting protrusion 600, the flow is diverted over and around the protrusion 600, and broken into smaller drops. When the laterally oscillating stream continues laterally on to the other extreme of its travel, it is not affected by protrusion 600. In the exemplary embodiment shown in FIG. 8, it was deemed desirable to smooth the heavy center of the spray without affecting the crisp edges of the spray. Therefore, first and second protrusions 600 are located closer to the outlet's vertical splitter 101A than to the outer edge of the spray.

FIGS. 9 and 10 show two options for breaking up the heavy ends of spray. One large protrusion 602 can be used, centered within the sweep of the oscillating stream (FIG. 9), or a spaced array of first and second protrusions 604 may be used, closer to the edges of the spray (FIG. 10). For a spray pattern providing a wider fan, using two protrusions is thought to be more effective for redistributing the spray's heavy ends. However, two separate protrusions or bumps may not fit under the desired fluid spray defining a narrower fan, so a single protrusion may be preferable. As noted above, the protrusions need not be circular in cross-section; an oval or racetrack-shaped protrusion is another option.

The effect of these protrusions on the fluidic's spray pattern is illustrated in FIG. 11, which shows the spray from a circuit similar to the one from FIG. 6, with added protrusions 600. The more typical fluidic's spray pattern is shown in FIG. 7 and illustrates heavy spikes in the spray pattern; those heavy spikes are suppressed by the protrusions 600 and the spray pattern's uniformity across a selected azimuth is improved (as seen in FIG. 11).

Larger protrusions will have more of an effect on the spray. Applicants were initially successful with protrusions 5-15% the height of the fluidic circuit's vertical extent, and later work has yielded beneficial results with protrusions or bumps with a height 5-15% the height of the fluidic circuit's vertical extent. The diameter of the protrusions can vary from a fraction of the throat width (as in the embodiment of FIG. 8) to the same order of magnitude as the throat width (FIG. 9). In an exemplary embodiment, bumps 600 are cylindrical protrusions, 0.30 mm in diameter. The top of the bumps can be parallel to the top of the chip (as opposed to being parallel to the floor of the circuit, which has an upward taper). The upstream side of the bump is 0.109 mm tall, which is approximately 7% of the throat depth. The bumps are symmetric about the splitter, 1.507 mm from center to center. The upstream side of the bump is located 0.953 mm downstream of the bottom of the mushroom. In this case, the location of the bump has been chosen to coincide with the heavy end of the oscillating fan while it dwells on the center.

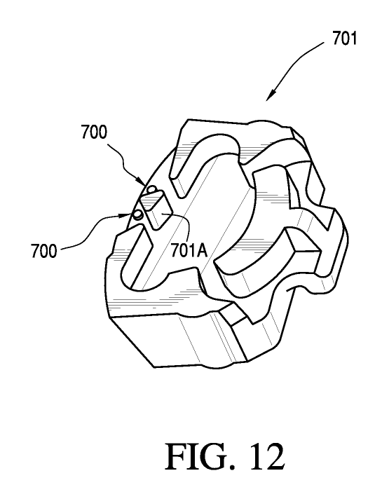

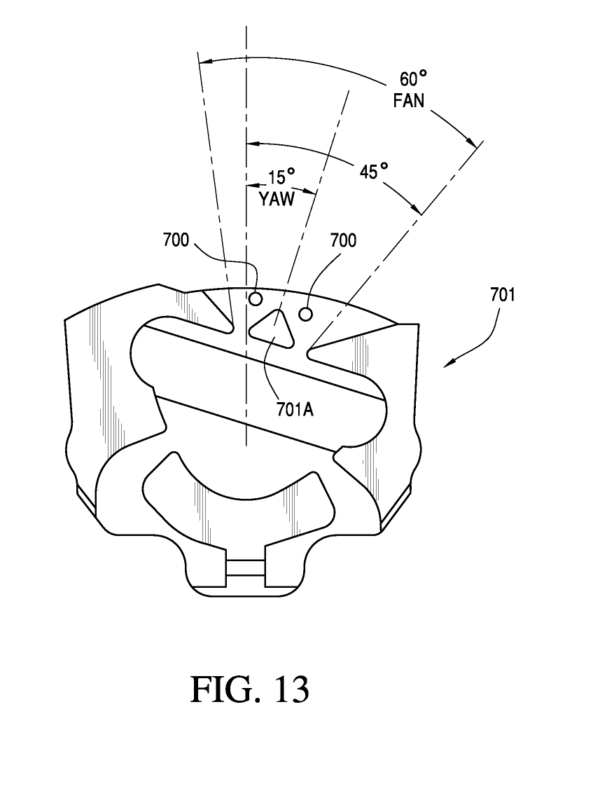

FIGS. 12 and 13 illustrate another fluidic circuit embodiment 701 that is configured to provide a spray pattern that is offset from the fluidic circuit's central axis by a selected yaw angle (e.g., 15 degrees). For the fluidic circuit 701, the exemplary aiming or yaw angle is selected to be 15 degrees, but could be a smaller (e.g., 2-7 degree) or greater (e.g., 20-40 degree) angle. There are various applications for a yawed fluidic circuit including the pattern-modifying bumps 700, in accordance with the present invention. In the exemplary embodiment shown in FIGS. 12 and 13, it was deemed desirable to smooth the heavy portion of the spray without affecting the edges of the spray. Therefore, first and second bumps or protrusions 700 are located symmetrically about and closer to the outlet's yawed vertical splitter 701A than to the outer edges of the spray.

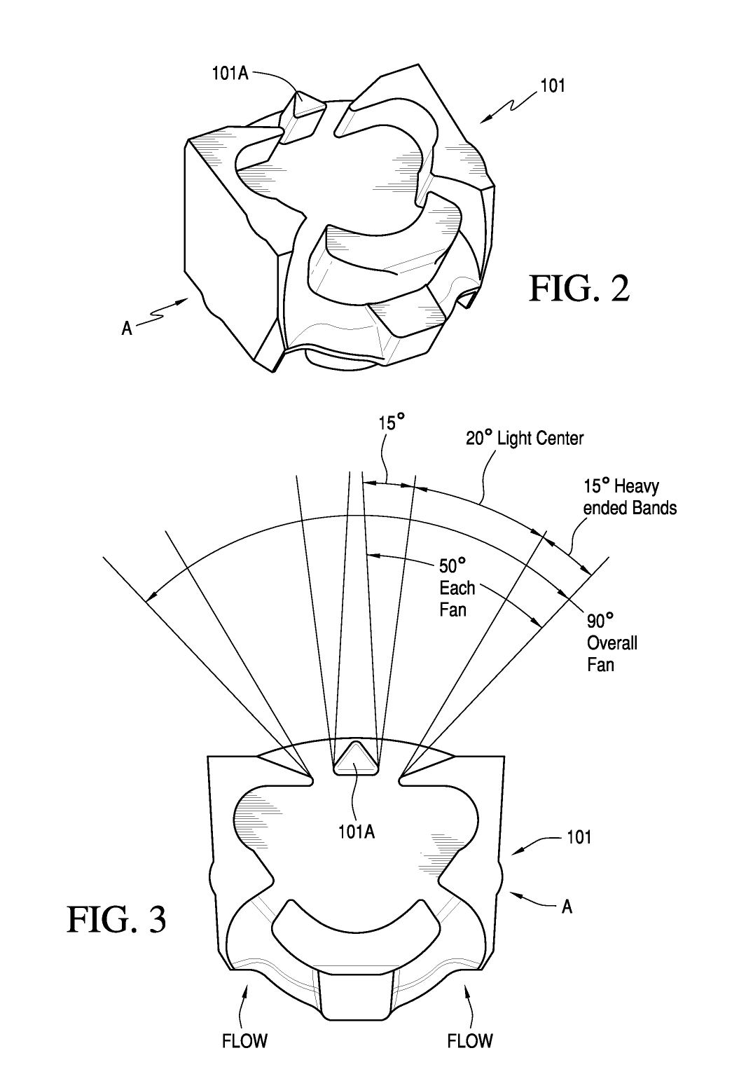

In addition to the exemplary embodiments shown in FIGS. 1A-13 it is possible to employ an embodiment using only one circuit. The mushroom circuit shown in FIGS. 2 and 3 can be used with no additional circuit. In configurations where the required throw and flow are less (8 foot and 10 foot throws), very tall protrusions, protuberances or bumps (30-50% of the throat height) can distribute enough of the heavy center band into the adjacent light regions to provide an acceptable distribution. The circuit could be placed on the top or the bottom of the fluidic circuit chip. The top would be preferable if one wished to increase the aim of the spray, the bottom would be preferable if one wished to aim the spray downward. However, space on the bottom of the chip is very limited.

Those having skill in the art will recognize that the structures, apparatus and methods of the present invention make available a fluidic oscillator adapted for use in a spray or nozzle assembly having no oscillating or rotating parts, with a body having a fluid inlet and a side all defining at least one fluidic circuit with an outlet configured with transversely projecting bumps (e.g., 600) or “speed bumps” that are placed to generate a selected spray pattern when fluid flows through the body. The fluidic circuit receives the fluid at its inlet and passes the fluid to its outlet, where the fluid oscillates in a patterned exhausted spray which passes, in places, past or over the bumps, and projects the fluid outwardly in the desired spray pattern.

While this fluidic circuit or oscillator structure has been described in an exemplary application employing a housing, the structure and method of the present invention is not limited to such applications. Generally speaking, the present invention comprises a fluidic oscillator (e.g., 601 or 701) with an inlet configured to receive pressurized liquid, an oscillating chamber in fluid communication with the inlet and configured to generate an oscillating liquid stream which oscillates through an oscillation fan pattern (e.g., as seen in FIGS. 8-10), an outlet including at least one throat having a selected throat width and configured to pass the oscillating liquid stream into the atmosphere, and at least one bump, protrusion or protuberance (e.g., 600, 601, 604 or 700) configured to project transversely into the oscillating liquid stream when the stream is at a selected portion of its fan pattern. The fluidic oscillator bump can be placed in proximity to the throat to project transversely into the fluid's oscillating stream proximate an extreme position of the pattern (i.e., at one or another end of the fan pattern), and the outlet can be configured with a floor carrying the bump(s) which project upwardly from the outlet floor by a selected height or vertical extent (as discussed above). The fluidic oscillator throat also has a selected height or vertical extent and the bump(s) project upwardly from the outlet floor to a transversely projected height in the range of 5-40% of the throat's height or vertical extent.

Having described preferred embodiments of a new and improved method, it is believed that other modifications, variations and changes will be suggested to those skilled in the art in view of the teachings set forth herein. It is therefore to be understood that ail such variations, modifications and changes are believed to fall within the scope of the present invention, as set forth in the claims.

What is claimed is:

1. A nozzle assembly including a fluidic circuit adapted to generate an oscillating stream with a spray pattern, comprising:
a housing with an interior and an exterior sidewall with at least one fluidic-circuit-receiving port carrying a fluidic insert with an inlet configured to receive a fluid passing into the housing and an outlet configured with at least a first transversely projecting bump selectively placed to project transversely into the passing fluid's oscillating stream;
wherein the fluidic circuit is configured to receive the fluid at its inlet and pass the fluid through to its outlet while generating an oscillating stream which flows past or over said bump, thereby modifying the nozzle assembly's spray pattern.

2. The nozzle assembly of claim 1, wherein said fluidic circuit has an outlet configured with at least one throat having a throat width, and wherein said bump is placed in proximity to said throat to project transversely into the fluid's oscillating stream proximate the extreme positions of said oscillating stream.

3. The nozzle assembly of claim 1, wherein said fluidic circuit has a floor with said bump projecting upwardly from said outlet floor by a selected height or vertical extent.

4. The nozzle assembly of claim 3, wherein said fluidic circuit's outlet has a selected throat width, and wherein said bump projects upwardly into said fluid circuit's outlet at 5-40% of the fluidic circuit's height or vertical extent.

5. The nozzle assembly of claim 4, wherein said bump has a diameter or lateral extent that is a fraction of the throat's width.

6. The nozzle assembly of claim 1, wherein said fluidic circuit is configured as a mushroom circuit.

7. The nozzle assembly of claim 1, wherein said fluidic circuit is configured with a splitter proximate said fluid circuit's outlet, said splitter having a selected width and defining a first throat on one side and a second throat on an opposing side;
wherein said first transversely projecting bump is selectively placed to project transversely into the first throat; and
wherein a second transversely projecting bump is selectively placed to project transversely into the second throat;
wherein the fluidic circuit is configured to receive the fluid at its inlet and pass the fluid through to its outlet while generating an oscillating stream which flows past or over said first and second bumps thereby modifying the nozzle assembly's spray pattern.

8. An assembly with a fluidic circuit, comprising:
(a) a housing with an interior and an exterior, with at least one fluidic-circuit-receiving port carrying a fluidic circuit insert with an inlet configured to receive a fluid passing into the housing, and an outlet configured to generate an oscillating spray pattern;
(b) wherein said fluidic circuit insert's outlet has a throat and a floor with bump features or protuberances projecting upwardly from said outlet floor by a selected height or vertical extent;
(c) wherein said fluidic circuit insert's outlet has a selected throat width;
(d) wherein the fluidic circuit insert receives the fluid at its inlet and passes the irrigation fluid through to its outlet, past or over one or more protuberances configured to project partly into the fluid's outward spray pattern, and modify the fluidic circuit's spray pattern by suppressing heavy bands.

9. The assembly of claim 8, wherein said fluidic circuit insert's protuberances project upwardly into said fluid circuit insert's outlet at 5-50% of the selected height or vertical extent.

10. The assembly of claim 8, wherein said fluidic circuit insert's protuberances have a diameter or lateral extent that is a fraction of the throat width.

11. The assembly of claim 8, wherein said fluidic circuit insert's protuberances are formed as transversely projecting right circular cylinders having a diameter that is less than one mm.

12. An enclosure for a fluidic oscillator that operates on a pressurized liquid flowing through said oscillator to generate a liquid jet that flows from said oscillator and into a surrounding environment to form an oscillating spray of liquid droplets, said oscillator having a boundary surface having fabricated therein a channel in the form of a fluidic circuit whose geometry is configured so as to aid in establishing the oscillating nature of said spray of liquid droplets, said enclosure comprising:
a body having an interior and an exterior surface;
wherein a first portion of said interior surface configured to attach to said oscillator boundary surface so as to form with said channel an enclosed pathway through which said liquid may flow;
wherein a second portion of said interior surface configured so as to provide a plurality of throats through which said pressurized liquid may exhaust; and
wherein at least one of said throats in said second portion includes at least one bump or protuberance configured to project into said exhausting pressurized liquid.

13. The enclosure as recited in claim 12, wherein: said body configured as a housing, with said exterior surface including: a front and a rear face and an intermediate boundary surface that connects said faces, and said interior surface including:
a passage that extends between said faces, with said passage having a front and a rear section,
said passage rear section forming a cavity having an opening in said body rear face and said cavity configured to allow for the insertion of said fluidic oscillator into said cavity,
said passage front section configured so as to include said plurality of throats, and
wherein at least one of said throats in said front section includes at least one bump or protuberance configured to project into said exhausting pressurized liquid and to alter the bands of liquid flow to render a substantially uniform pattern from the jet's oscillating spray.

14. A method of forming an enclosure for a fluidic oscillator that operates on a pressurized liquid flowing through said oscillator to generate a liquid jet that flows from said oscillator and into a surrounding environment to form an oscillating spray of liquid droplets, said oscillator of the type having a boundary surface having fabricated therein a channel in the form of a fluidic circuit whose geometry is configured so as to aid in establishing the oscillating nature of said spray of liquid droplets, said method comprising the steps of:
(a) utilizing a body having an interior and an exterior surface,
(b) configuring a first portion of said interior surface to attach to said oscillator boundary surface so as to form with said channel an enclosed pathway through which said liquid may flow,
(c) configuring a second portion of said interior surface so as to provide a plurality of throats thought which said pressurized liquid may exhaust; and
(d) configuring at least one bump or protuberance to project into said exhausting pressurized liquid.

15. The method as recited in claim 14, furthering including the steps of:
(e) configuring said body as a housing, with said exterior surface including: a front and a rear face and an intermediate boundary surface that connects said faces, and said interior surface including: a passage that extends between said faces, with said passage having a front and a rear section,
(f) configuring said passage rear section to have a cavity with an opening in said body rear face and configured to allow for the insertion of said fluidic oscillator into said cavity,
(g) configuring said passage front section so as to include said plurality of throats, and
(h) configuring said bump or protuberance to project into said exhausting pressurized liquid, and to alter the bands of liquid flow to render a substantially uniform pattern from the jet's oscillating spray.

16. A fluidic oscillator, comprising:
an inlet configured to receive pressurized liquid;
an oscillating chamber in fluid communication with said inlet, and configured to generate an oscillating liquid stream which oscillates through an oscillation fan pattern;
an outlet including at least one throat having a selected throat width and configured to pass said oscillating liquid stream into the atmosphere, and
at least one bump, protrusion or protuberance configured to project transversely into said oscillating liquid stream when said stream is at a selected portion of said fan pattern.

17. The fluidic oscillator of claim 16, wherein said bump is placed in proximity to said throat to project transversely into the fluid's oscillating stream proximate an extreme position of said pattern.

18. The fluidic oscillator of claim 16, wherein said outlet has a floor with said bump projecting upwardly from said outlet floor by a selected height or vertical extent.

19. The fluidic oscillator of claim 18, wherein said throat also has a selected height or vertical extent and wherein said bump projects upwardly from said outlet floor to a projecting height in the range of 5-40% of the throat's height or vertical extent.

20. The fluidic oscillator of claim 16, wherein said oscillating chamber is configured to generate an oscillating liquid stream which oscillates through an oscillation fan pattern that is laterally offset at a selected yaw angle;
wherein said outlet's throat is configured to pass said oscillating liquid stream into the atmosphere at said selected yaw angle, and wherein bump is placed in proximity to said throat to project transversely into the fluid's oscillating stream proximate a selected position of said fan pattern.
